(19) United States
(12) Patent Application Publication
(10) Pub. No.: US 2009/0128436 A1
(43) Pub. Date: May 21, 2009

(54) On-chip inductor with trimmable inductance, a method for making the same and a method for adjusting the impedance of the inductance

(75) Inventors: Lihui Guo, Singapore (SG); Alexander Pavlovich Popov, Vista Park (SG)

Correspondence Address: CONNOLLY BOVE LODGE & HUTZ LLP, 1875 EYE STREET, N.W., SUITE 1100, WASHINGTON, DC, 20006, US

(73) Assignee: Agency for Science, Technology and Research

(21) Appl. No.: 11/911,468

(22) PCT Filed: Apr. 14, 2005
(86) PCT No.: PCT/SG05/00123

§ 371 Date: Jun. 10, 2008

(51) Int. Cl. H01Q 13/00

(52) U.S. Cl. 343/772

(57) ABSTRACT

Means for trimming an inductor on a chip for use in RFID tags. The inductor coil (4) is manufactured on a chip (1) and covered with a dielectric layer (3). Upon the dielectric layer (3) strips (5) are made above the inductor (4) thus forming a capacitor in parallel with the inductor. The strips (5) may be of different widths and one end of each may be electrically connected (6) to the inductor. Selective removal of strips (5) allows the capacitance in parallel to the inductor to be adjusted and so the effective inductance as seen by an external circuit is adjusted.

### BACKGROUND OF THE INVENTION

1. Field of the Invention

The invention relates to an on-chip inductor with trimmable inductance and a method for making such an inductor, which can be used for high frequency integrated circuits, and more particularly as an antenna used in RFID tags. The invention relates also to a method for adjusting the impedance of the inductor.

2. Description of the Related Art

On-chip antennas of RFID tags are normally conductive coils, the inductance of which need to be matched with the associated RFID tag. Particularly, the inductance of the antenna should have a value with which a resonance condition can be reached together with the capacitance constituted by the circuit to which it is connected, whereby optimum performance can be attained.

On-chip inductors used in RF integrated circuits (RFIC) also need accurate values for applications, e.g. in RF matching circuits and filter circuits. Since mass production cannot ensure exact inductance values, the required inductance value should be adjusted. Adjusting is generally provided by a gradual trimming of predetermined shunt paths provided in the inductive path. Such an adjustment has become very important in RF applications, particularly in high GHz frequency circuits.

Circuits of RFID tags with on-chip antennas and RFICs with on-chip inductors are widely fabricated with foundries' standard CMOS technology to achieve low cost. Therefore, to find a trimming method associated with the-state-of-art foundries' fabrication environment will be much helpful to design and manufacture RFID tags with on-chip antennas and RFICs. Such trimming should be carried out in a short time and with low costs.

In state-of-the-art solutions the inductors or inductive antennas are trimmed by changing the effective length of the inductive path of the device. U.S. Pat. No. 6,480,110 discloses a solution particularly for antennas used in RFID tags working at a relatively low frequency, e.g., 13.56 MHz, in which each antenna is designed and made on an insulating substrate, being generally a card, with several centimeters in size. The RFID tags' circuit dies are attached to the substrate and connected separately with the ports of the associated antenna. So, they cannot be regarded as RFID tags with on-chip antennas. If the method disclosed in the cited U.S. Pat. No. 6,480,110 would be applied to on-chip inductive antennas or on-chip inductors, it would be connected with certain technical problems. For example, as discussed in another prior art specification, namely in U.S. Pat. No. 6,369,684, the tunable metal wires in the centre region of the coil adversely influence the magnetic field generated by the coil. As a result, the losses increase and the quality coefficient Q of the inductance gets greatly decreased.

As disclosed in U.S. Pat. No. 6,369,684 an extra surface area is needed for the layout of tunable wire lines. The increased size increases costs when applied in chip-level implementations. If it is applied for on-chip inductors, the relevant compact model is complicated, which is not friendly to a circuit design environment.

To overcome the aforementioned drawbacks a trimming method for on-chip inductors is disclosed in US 2004/0063039, which is based on the principle of tuning the intrinsic capacitor between winding lines of a coil that forms the inductance. Here a method for trimming high frequency inductance of a passive component is disclosed, which includes the steps of forming a first dielectric layer on an insulation substrate, forming an inductance pattern (coil) on the upper surface of the first dielectric layer, forming a second dielectric layer on the inductance pattern, and forming a spaced metal layer pattern on the upper surface of the second dielectric layer. In such a design the adjustment of the inductance value can be easily performed by laser trimming of the upper metal layer pattern. This trimming method has proven not sufficiently efficient and it can ensure a comparatively low adjustment range only. The design occupies a large surface area on the tuned inductors.

### SUMMARY OF THE INVENTION

Accordingly, it is an object of the present invention to provide an on-chip inductor with trimmable inductance that can be applied to high frequency integrated passive devices, wherein the trimming can be carried out efficiently in a broad adjustment range.

Another object of the present invention is to provide a method to trim on-chip inductors and on-chip RFID tags' inductive antennas with in an effective way, which can also be carried out in CMOS interconnect process or CMOS compatible process or relevant chip packaging process.

A further object of the invention is to provide an efficient adjustment method by which the desired inductance can be set in a fast, accurate and easy way.

To achieve the above-mentioned objects it has been found that the range of adjustment will be noticeably higher if the spaced capacitive metal layer surfaces arranged above and partially covering (overlapping) the underlying adjacent winding lines are electrically connected at one of their end zones with one of the coil lines underneath. This connection will not decrease the quality coefficient of the inductance.

According to the invention an on-chip inductor with trimmable inductance has been provided that comprises:
at least one electrically conductive path constituting the inductor and acting as a RF antenna provided on a substrate, the path defining a plurality of spaced conductive lines;
a dielectric layer on the conductive path;
at least one strip provided on the dielectric layer spaced from and partially covering at least two lines of the conductive path underneath, to represent a capacitance;
respective connecting pads associated with and electrically connected to a respective one of the strips, each connecting pad extends through the dielectric layer and connects the strip with only one of the lines;
   wherein trimming of the strips can be performed by selectively separating the strips in two respective parts, preferably just above the spacing between the two lines underneath. The separation is often referred to as “chopping”.

In an embodiment of the invention, when the underlying structure is a CMOS structure, the on-chip inductor is formed in the top metal layer of a CMOS interconnect. In this case, the manufacturing costs can be reduced if the strip(s) and the connecting pad(s) are formed along with a CMOS pad process.

According to a further embodiment of the invention, the adjustment, that is the trimming of the inductance, can be carried out in an even easier and more accurate way if at least some of the strip(s) have different widths thus representing respective different capacitance values.

A possible field of application lies in the connection of the path to an RFID tag to form the antenna thereof.

According to the invention a method has also been suggested for providing a variable inductance of an on-chip inductor by trimming, that comprises the steps of:

forming a long electrically conductive path having several spaced lines on a substrate with a predetermined inductance to constitute an inductor and to act as a RF antenna;
forming a dielectric layer on the electrically conductive path;
forming at least one metal layer strip on the dielectric layer spaced from and partially covering at least two of the lines of the electrically conductive path underneath;
electrically connecting only one end of the strip with one of the lines underneath by a connecting pad through the dielectric layer; and
varying the inductance by reducing the strip capacitance by separating the strip in two parts.

According to an exemplary embodiment of the invention, a plurality of strips is provided in a spaced apart arrangement during the metal layer strip forming step, wherein the strips can have different widths.

In such cases during the inductance-varying step the strips with different widths are selectively chopped, whereby a coarse and fine adjustment can be realized.

According to a further aspect of the invention a method has been provided for adjusting the inductance of an on-chip inductor to a required value that comprises the steps of:
forming a long electrically conductive path that has several spaced lines on a substrate with a predetermined inductance to constitute the inductor and to act as a RF antenna;
forming a dielectric layer on the electrically conductive path;
forming a plurality of discrete metal strips with differing width on the dielectric layer spaced from and partially covering at least two adjacent lines underneath, each of the strips represent a transformed capacitance value proportional to the actual width thereof; and
trimming the strips by separating them in a stepwise manner to achieve to the required inductance value.

The adjustment will be faster if the method further comprises the steps of measuring the actual inductance value prior to each trimming step to determine the difference relative to the desired value and selecting the next strip to be trimmed depending on the so determined difference, wherein a greater difference in the inductance value is achieved by separating a wider strip and a smaller difference is achieved by separating a narrower strip.

This adjustment method can be carried out even if the strips on the dielectric layer are not connected electrically with any of the lines underneath, however, such a connection is preferable because it widens the range of adjustment by increasing the transformed capacitance.

The invention provides a simple solution to the problem to be solved, it perfectly fits to CMOS manufacturing technology and it can be built integrally together with the RFID circuit.

Features and advantages of the invention will be apparent from the following description of preferred embodiment, given for the purpose of disclosure and taken in conjunction with the accompanying drawings.

### BRIEF DESCRIPTION OF THE DRAWINGS

FIG. 1 is a top-side view of a variable inductor according to an embodiment known from prior art;

FIG. 2 is a cross-section of the variable inductor of FIG. 1 along lines A-A;

FIG. 3 shows a trimming process with the variable inductor of FIG. 1;

FIG. 4 is a cross-section of the trimmed variable inductor of FIG. 3 along lines B-B;

FIG. 5 shows a common circuit model for the arrangements of FIG. 1 and FIG. 3;

FIG. 6 is a top-side view of a possible embodiment of the variable inductor according to the invention;

FIG. 7 is a cross-section of the variable inductor of FIG. 6 along lines C-C;

FIG. 8 shows a diagram indicating trimming results achieved by the variable inductor according to the invention; and

FIG. 9 shows another example of implementation of the invention.

### DETAILED DESCRIPTION OF THE PREFERRED EMBODIMENTS

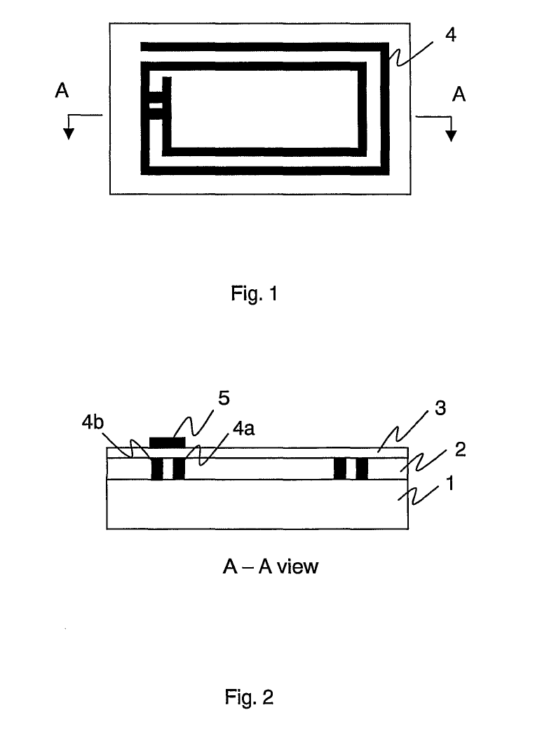

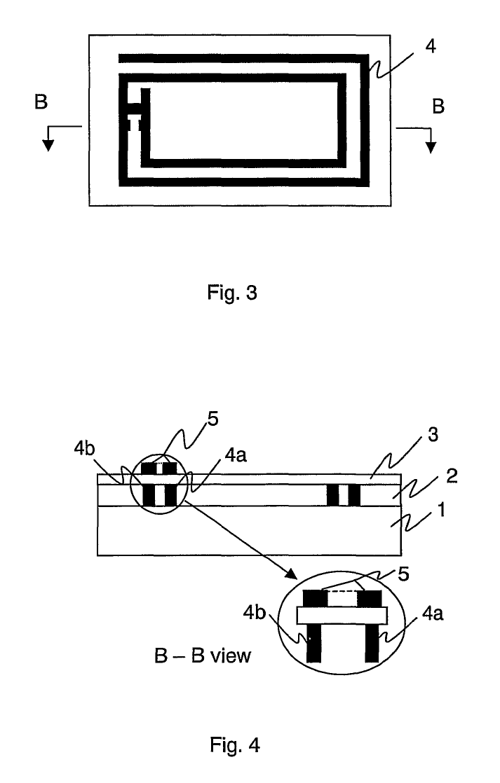

As shown in FIGS. 1 and 2, a coil 4, made of a conductive material, for example aluminum or copper, of an on-chip inductor is provided in a metal layer 2 on an integrated circuit chip. A dielectric layer 3 covers the metal layer 2 and therefore the whole inductor. Tuning metal strips 5 made e.g. of aluminum and constituting trimming members are built on the dielectric layer 3 over adjacent lines 4a and 4b of the coil 4 to form a capacitor with the two lines 4a and 4b, because the strips 5 cover (overlap) the corresponding areas of the lines 4a and 4b. The capacitance, and thereby the inductance, can be varied by a trimming process shown in FIGS. 3 and 4, wherein the strips 5 can be cut or chopped one by one at respective positions between the lines 4a and 4b to achieve the required value of effective inductance. This separation can be done by using milling technology, e.g. using Focused Ion Beam (FIB) or with laser as well known for a person skilled in the art. The tuning principle is disclosed in said US 2004/0063039 in detail.

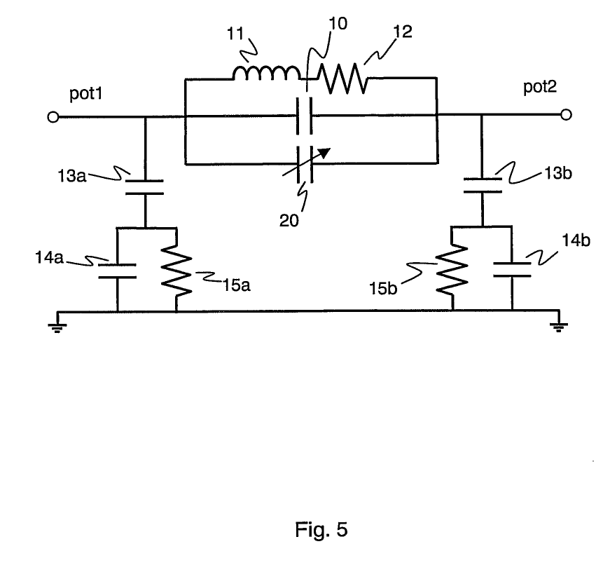

In FIG. 5, which is a common substitute circuit network model of the design shown in FIGS. 1 to 4, reference numeral 11 designates the intrinsic inductance of the coils; 12 represents the resistance introduced by the coil 4; 10 indicates the capacitance between the windings of the coil 4; 13a and 13b show the capacitance introduced by the dielectric layer 3 underneath the strips 5; 14a, 14b, 15a and 15b designate respective pairs of capacitor and resistor introduced by the substrate of the chip. The strips 5 perform the function of a variable capacitor 20 shown in FIG. 5. The effective inductance of the network shown in FIG. 5 can be expressed as

L_{eff}=[image(1/Y(1,1))]/2πf

where, Y(1,1) comes from the Y-parameters of the network, which is a function of the actual values of the components in the network. It can be proven that the value of the inductance L_{eff} increases when the capacitance of the variable capacitor 20 becomes greater.

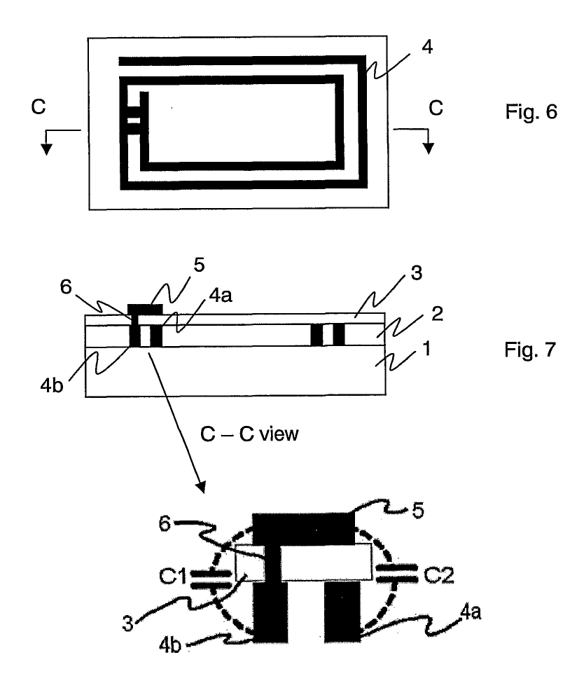

FIGS. 6 and 7 show an embodiment of the present invention, wherein one end of the strip 5 is electrically connected by a connecting pad 6 made of electrically conductive material, for example aluminum or copper, with one of the lines 4a or 4b, e.g. 4b, of the coil 4. The variable capacitance 20 in FIG. 5 provided by the tunable strip 5 has a wider range of adjustment compared with the possible adjustment of the coil described in US 2004/0063039 mentioned above. The wider range of adjustment will be apparent if the internal capacitances formed between the respective coil lines 4b and 4a (see enlarged part of FIG. 7) and the metal strip 5 are considered. First, the conditions without the interconnection pad 6 should be considered. Between the outer coil line 4b and a portion of the strip 5 overlapping it an internal capacitance C1 is formed. Similarly, a capacitance C2 is formed between the inner coil line 4a and a portion of the strip 5 overlapping the inner coil line 4a. The two capacitors C1 and C2 are connected in series between the coil lines 4a and 4b, so that the resulting capacitance constitutes a capacitive load for the last turn of the coil. It is known that the resulting capacitance of two capacitors connected in series is always smaller than any of the two component capacitors, and if C1=C2, the resulting capacitance will be the half of this capacitance. According to the invention, the pad 6 shorts the capacitor C1 and leaves the capacitor C2 unchanged. The resulting capacitance between the two coil lines 4a and 4b is, therefore, about twice as high as if the pad 6 did not exist. A larger transformed capacitance between the coil winding exerts a greater change on the overall reactance of the coil, thus the presence of the pad 6 is very significant. When the strip 5 is cut in the middle, the connection path is broken, and the effective capacitance between the lines 4b and 4a will be much smaller. In this way the step of interconnecting one of the lines 4b or 4a with the metal strip 5 above it practically doubles the value of the transformed capacitance, which increases the range of adjustment.

As a practical example, when the structure underlying the on-chip inductor according to the invention is a CMOS structure, the coil 4 of the on-chip inductor can be realized in the top metal layer of interconnect in standard CMOS back end of line (BEOL). Therefore, the connecting pad 6 extending through the dielectric layer 3 and interconnecting the strip 5 and the coil line 4b, can be formed in association with the pads' open process in standard CMOS BEOL. Accordingly, the strip 5 can be fabricated along with the CMOS aluminum pads' manufacturing process. Hence, no extra process and mask is required for the implementation of the present invention.

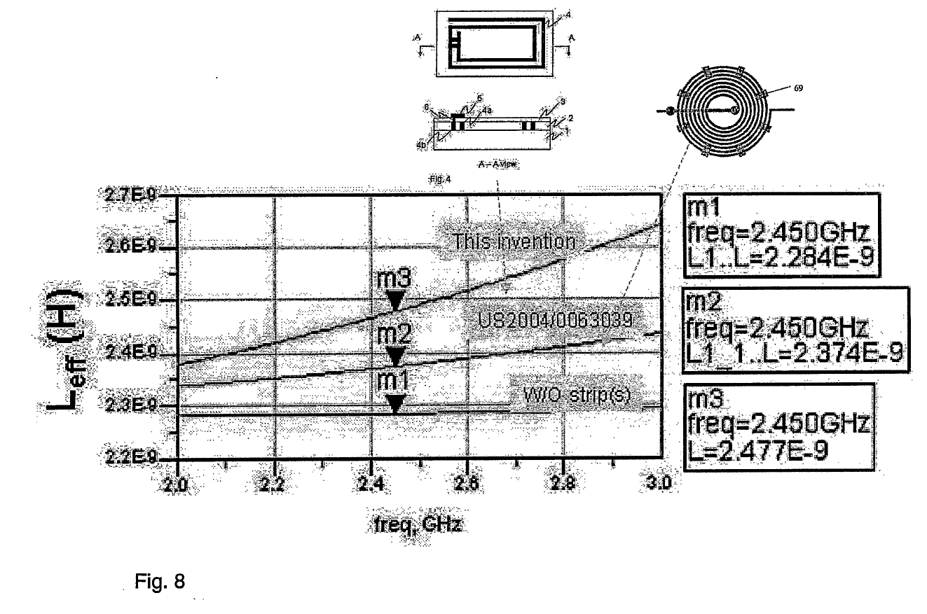

FIG. 8 shows three diagrams indicating simulated results showing variation of the inductance L_{eff} as a function of frequency, demonstrating that the invention can greatly improve the trimming efficiency compared to the closest prior art. In higher frequencies the invention is even more effective. In FIG. 8, the inductance of the coil 4 alone, i.e. without the tunable strip(s) 5 above it is also given as a reference, and it is designated by the line wherein the marker m1 is shown. Marker m2 is associated with the line showing the inductance characteristic achieved according to US 2004/0063039 and the upper line with marker m3 shows the inductance characteristic to the present invention.

The number of lines 4a, 4b of the coil 4 can be more than two, and the strip 5 can cover at least two lines 4a, 4b but it can also cover more than two. One important feature and advantage of the invention is that each strip 5 used for tuning the capacitance formed between the lines 4a, 4b of the coil 4 should be connected with one and only one of the lines 4a or 4b of the inductive coil 4 underneath through the associated connecting pad(s) 6.

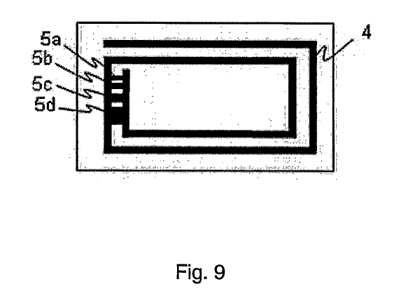

FIG. 9 shows another exemplary embodiment of the invention, wherein strips 5a to 5d with different widths are used. In this way a flexible trimming can ensure both coarse and fine adjustment. A small tuning step is obtained if a strip 5 with narrow width is chopped, e.g. strip 5a in FIG. 9. Conversely, the tuning step will be large when a wide strip 5 is chopped, e.g. strip 5d. If the inductance is measured and compared with the desired value, the difference can be calculated, and following some experiments, the strip(s) with the optimum widths, which can compensate this difference, can be determined and chopped.

Furthermore, in the embodiment shown in FIG. 9 each strip, from 5a to 5d, has one side connected with the associated line 4a or 4b of the coil 4 underneath.

While the present invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

What is claimed is:

1. On-chip inductor with trimmable inductance, comprising:
at least one electrically conductive path constituting said inductor and acting as a RF antenna provided on a substrate, said path defining a plurality of spaced conductive lines;
a dielectric layer on said conductive path;
at least one strip of an electrically conductive material being provided on said dielectric layer spaced from and partially covering at least two lines of said conductive path underneath, to represent a capacitance;
respective connecting pads associated with and electrically connected to a respective one of said strips, each connecting pad extending through the dielectric layer and connecting said strip with only one of said lines;
wherein trimming of said strips can be performed by selective separation of said strips in two parts.

2. The inductor as claimed in claim 1, wherein said on-chip inductor is formed in the top metal layer of a CMOS interconnect.

3. The inductor as claimed in claim 1, wherein said strip(s) and said connecting pad(s) are formed with a CMOS pad process.

4. The inductor as claimed in claim 1, wherein at least some of said strip(s) have different widths.

5. The inductor as claimed in claim 1, wherein said path is connected to an RFID tag to form the antenna thereof.

6. A method for providing a variable inductance of an on-chip inductor by trimming, comprising the steps of:
forming a long electrically conductive path comprising several spaced lines on a substrate with a predetermined inductance to constitute said inductor and to act as a RF antenna;
forming a dielectric layer on said electrically conductive path;
forming at least one metal layer strip on said dielectric layer spaced from and partially covering at least two of said lines underneath;
electrically connecting only one end of said strip with one of said lines underneath by a connecting pad through said dielectric layer; and
varying said inductance by reducing the strip capacitance by separating said strip in two parts.

7. The method as claimed in claim 6, comprising the step of providing a plurality of said strips in a spaced arrangement during said metal layer strip forming step.

8. The method as claimed in claim 6, wherein during said electrically conductive path forming step said path being formed in the top metal layer of a CMOS interconnect.

9. The method as claimed in claim 6, wherein during said electrical connecting step said electrical connection being realized by a connection pad provided by a CMOS pad process.

10. The method as claimed in claim 6, wherein said steps of forming said path, dielectric layer, strip(s) and electrical connection constituting parts of a post CMOS process on a silicon based chip.

11. The method as claimed in claim 6, wherein during said metal layer strip forming step providing a plurality of said metal strips to be spaced from each other and to have respective different widths.

12. The method as claimed in claim 11, wherein during said inductance-varying step selectively carrying out said separation step with different widths to provide a coarse/fine adjustment.

13. A method for adjusting the inductance of an on-chip inductor to a required value, comprising the steps of:
forming a long electrically conductive path comprising several spaced lines on a substrate with a predetermined inductance to constitute said inductor and to act as a RF antenna;
forming a dielectric layer on said electrically conductive path;
forming a plurality of discrete metal strips with differing width on said dielectric layer spaced from and partially covering at least two of said lines underneath, each of said strips representing a transformed capacitance value proportional to the actual width thereof;
trimming said strips by separating them in a stepwise manner to arrive to the desired inductance value.

14. The method as claimed in claim 13, further comprising the step of electrically connecting only one end of said strips with one of said lines underneath by a connecting pad through said dielectric layer prior to said trimming step to increase thereby the range of adjustment.

15. The method as claimed in claim 13, further comprising the steps of measuring the actual inductance value prior to each trimming step to determine the difference relative to said required value and selecting the next strip to be trimmed depending from said difference, wherein a wider strip corresponds to a greater difference and a narrower one to a smaller difference.
